(19) United States
(12) Patent Application Publication
(10) Pub. No.: US 2004/0134649 A1
(43) Pub. Date: Jul. 15, 2004

(54) Carpet cleaning system

(76) Inventors: Paul Richardson, Salisbury, MA (US); Richard Forrest, Pelham, NH (US)

Correspondence Address: Kevin S. Lemack, Nields & Lemack, Suite 7, 176 E. Main Street, Westboro, MA, 01581, US

(21) Appl. No.: 10/341,800

(22) Filed: Jan. 14, 2003

(51) Int. Cl. G05D 23/00

(52) U.S. Cl. 165/292; 165/287; 165/294; 165/297; 165/299

(57) ABSTRACT

A truck-mounted carpet-cleaning system that replaces the separate heat exchangers used in conventional systems having a single unit. It also merges several exhausts before they are used in the exchanger. This allows the system to be able to better regulate the temperature of the water. This improved regulation eliminates the need for a water bypass system. Because of the improved heat exchange system, the solenoids, sensors, thermo relief valves, bypass orifices and other components found in traditional systems can be eliminated. This results in a more reliable system, with more tightly regulated water temperature.

### BACKGROUND OF THE INVENTION

There are two categories of truck-mounted carpet cleaning systems. Direct drive systems, or van-powered systems, are powered by the engine of the vehicle on which they are installed. Slide-in systems are self-contained units that are powered by their own engines.

Truck mounted carpet cleaning systems typically use powerful vacuums, combined with hot water and chemicals to achieve their results. The hot water is necessary for proper cleaning as well as minimal carpet drying time. This hot water is typically generated by heat exchangers. Heat can be extracted from the vehicle's engine exhaust, the system's engine exhaust, from engine coolant or from the blower exhaust. Traditionally, carpet-cleaning systems utilize separate heat exchangers for extracting heat from each of a variety of sources.

Typical systems employ multiple heat exchangers. For example, one heat exchanger utilizes the exhaust from the blower, which is in the range of 250° to 300° F. This preheats the water to an intermediate temperature, which is less than ideal for cleaning. The main exchanger utilizes the exhaust from the system's engine or the vehicle's engine. This exhaust is much hotter, typically in excess of 1000° F. This exchanger heats the water to the ideal temperature for cleaning, which is about 250-280° F. (alternatively, the main exchanger can be used to preheat the water and the blower exhaust (or lower temperature source) can be used as the main heat source). However, since the engine exhaust is so hot, it is possible to overheat the water in the exchanger. In order to prevent the water from overheating, the systems are equipped with a manual or automatic heat diverter, which routes the high temperature exhaust gases away from the main heat exchanger. The systems are also equipped with a bypass system to move heated water out of the system to either a recovery tank or to a fresh water supply tank if the water reaches a predetermined temperature. Cooler water is then drawn into the system.

This technology allows for acceptable water temperature, but requires many electrical sensors, thermo relief valves, bypass orifices and solenoids that are prone to failure to implement the bypass system. In addition, the system can experience large variations in water temperature and add unwanted water to the recovery tank.

### SUMMARY OF THE INVENTION

The problems of the prior art have been overcome by the present invention, which is directed to a heat exchanger wherein the heat exchange fluid is a combination of fluids having two different temperatures, to a method of heating a fluid with a heat exchanger, to a control system for regulating the temperature of a fluid being heated, and to a carpet cleaning system utilizing the control system. In particular, the present invention replaces the separate heat exchangers conventionally used with a single unit. It also merges several exhausts and uses these merged exhausts as the heat exchange medium in the heat exchanger. This merger results in a mixed exhaust temperature that is significantly higher than the temperature of the blower exhaust alone, but also significantly lower than the temperature of the system engine's exhaust. This intermediate temperature allows the system to be able to better regulate the temperature of the fluid being heated and eliminates the need for a bypass system. Because of the improved heat exchange system, the solenoids, sensors and other components found in traditional systems can be eliminated. The large fresh water tank can be eliminated, or can be maintained as an on-board water supply but devoid of bypass. The present invention therefore results in a more reliable system, with more tightly regulated water temperature.

### BRIEF DESCRIPTION OF THE DRAWINGS

FIG. 1 is a flow schematic of an exemplary existing carpet cleaning system;

FIG. 2 is a flow diagram of the preferred embodiment of the present invention;

FIG. 3 is a cross section of the heat exchanger used in the present invention; and

FIG. 4 is a flow diagram of an alternative embodiment of the present invention.

### DETAILED DESCRIPTION OF THE INVENTION

Traditionally, carpet-cleaning systems utilize the heat contained within various exhausts to raise the temperature of the cleaning fluid. Several sources of exhaust can be used, including but not limited to, the exhaust from the engine of the vehicle onto which the system is mounted, the exhaust from the blower which is needed to create the high flow used to extract fluid and debris from the surface being cleaned, and the exhaust from the engine powering the system itself.

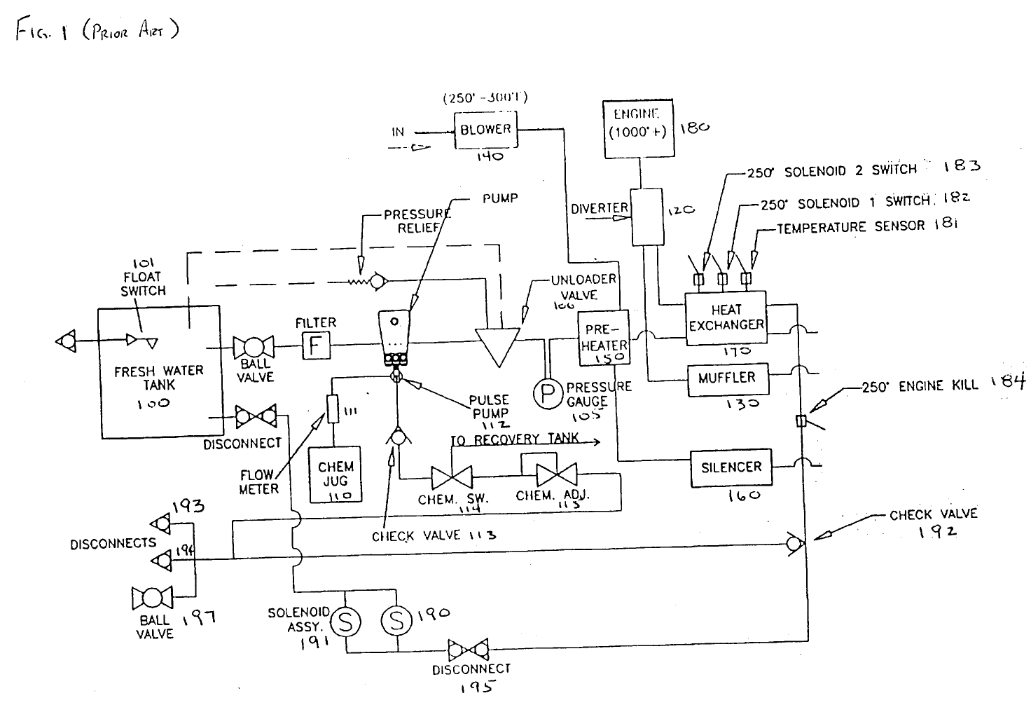

FIG. 1 shows the flow diagram of a traditional carpet cleaning system. Fresh water is stored in a large fresh water tank 100, which typically is about 75-100 gallons. The tank 100 can be in fluid communication with a fresh water source, and a float valve 101 can be used to draw additional water into the tank from the water source as it is used by the system. The water passes through ball valve 102 and through filter 103, as it is drawn into a hydraulic or pressure pump 104. Although this embodiment uses a ball valve and a filter, these are not critical to the operation of the system. The pump 104 continuously draws water, even at times when the system is not using the water to clean carpets. The pressure created by the pump 104 can be made viewable using pressure gauge 105. This gauge is preferably mounted in a location where it is visible to the operator. Unloader valve 106 is used to insure that the pressure remains in the safe region. Excess water is removed by the unloader valve and preferably returned to the water tank 100. Excessive pressure is relieved through pressure relief 107. Traditionally, the water is then passed through a preheater 150, which is used to preheat the water to an elevated temperature. The preheater typically uses the heat from the exhaust from the blower 140 to transfer heat to the water. The temperature of this exhaust is typically in the range from 250° to 300° Fahrenheit. After passing through the preheater 150, the exhaust from the blower 140 is dispersed into the air, preferably after passing through silencer 160, which can be used to reduce the noise emissions. The preheated water is then fed through the primary heat exchanger 170, where it is heated to its final temperature, preferably at or about 230° Fahrenheit. The exhaust from the system engine 180, which is typically near 1000° F., is preferably used as the heat source for the heat exchanger 170. The exhaust from the vehicle's engine could also be used to provide this heat. In this embodiment, the heat exchanger 170 contains a temperature sensor 181 to monitor the temperature of the water in the heat exchanger. The temperature is measured at two spatially separated locations within the heat exchanger. The first location is further downstream than the second, such that the water temperature at the first location will typically be higher than at the second point, as more heat has been transferred by the heat exchanger. When the temperature sensor detects a first temperature at the first location, usually in the range of 250° F., it actuates a mechanism to reduce the overall temperature of the water in the system. This is accomplished by activating a first solenoid switch 182. This switch 182 is used to actuate solenoid 190, which opens a return path to allow the overheated water to flow to the fresh water tank 100. Disconnects 195 and 196 are implemented in this embodiment, however, they are not critical to the operation of the system and can be eliminated. By returning water to the fresh water tank, a closed loop is established which allows water to circulate from the fresh water tank 100, through the pump 104, the preheater 150 and the heat exchanger 170 and back into the fresh water tank. Because of the temperature of the exhaust in the heat exchanger, it is important that water not remain stagnant within the exchanger, as its temperature will become dangerously high. This flow of water reduces the amount of time that water remains stagnant inside the heat exchanger, thereby cooling the overall temperature of the water in the system. This cooling effect could also be accomplished by sending the overheated water to the recovery tank, however this method wastes water and valuable space within the recovery tank. When the temperature sensor 181 detects a second temperature at the second location, typically in the range of 250° F., additional actions are taken to reduce the temperature of the water. In this embodiment, a second solenoid switch 183 is used to actuate a second solenoid 191. This serves to increase the flow of water within the system, thereby further reducing the temperature of the water. Additionally, it may be necessary to reduce the temperature of the air within the heat exchanger as another method of lowering the temperature of the water within the system. In this embodiment, an air diverter 120 is used to direct the engine exhaust away from the heat exchanger 170 and into a muffler 130. By diverting the hot air, the heat exchanger transfers less heat to the water, thereby further reducing its temperature. An engine kill switch 184 monitors the temperature of the water leaving the heat exchanger. If that temperature is higher than a predetermined value, such as 250° F., the system engine will be shut down. Water used to clean carpets exits the heat exchanger 170, passes through check valve 192, and continues to disconnects 193 and 194 and to ball valve 197. In this embodiment, these disconnects are located on the front panel of the cleaning system and the cleaning hoses are attached to them. Other implementations can be used to connect the heated water from the heat exchanger to the cleaning hoses. These methods are well understood by those skilled in the art. Carpet cleaning chemicals can be mixed with the heated water. In this embodiment, chemical jug 110 contains the required chemicals. A pump draws the chemical from the jug. In this embodiment, this pump is a pulse pump 112, which operates in conjunction with pump 104. The flow rate of the chemical(s) can be monitored by a suitable device, preferably a flow meter 111 directly in the fluid path of the chemical(s). The flow meter is preferably mounted on the front panel of the system, where it is visible to the operator. The chemical(s) flows through a check valve 113 and to a chemical switch 114. This switch preferably has three positions; off, where no fluid is passed; on, where fluid is passed through the switch; and priming, where fluid is allowed to flow, however it flows into the recovery tank. This allows the flow of the chemical(s) to begin without adding it into the heated water. If chemical switch 114 is in the on position, the chemical(s) flows through the chemical adjust 115. This device regulates the flow of chemical(s) into the system, which can be monitored by the flow meter 111. The chemical(s) then merges with the heated water before the disconnects 193 and 194.

The existing systems, as described above, cannot adequately regulate the temperature of the heat exchanger 170, and therefore must implement safeguards to guarantee that the temperature of the water remains in a safe range. These safeguards include multiple switches and solenoids, which can be unreliable and costly, and a large fresh water tank, which is both heavy and bulky. These safeguards can be safely eliminated by using the present invention.

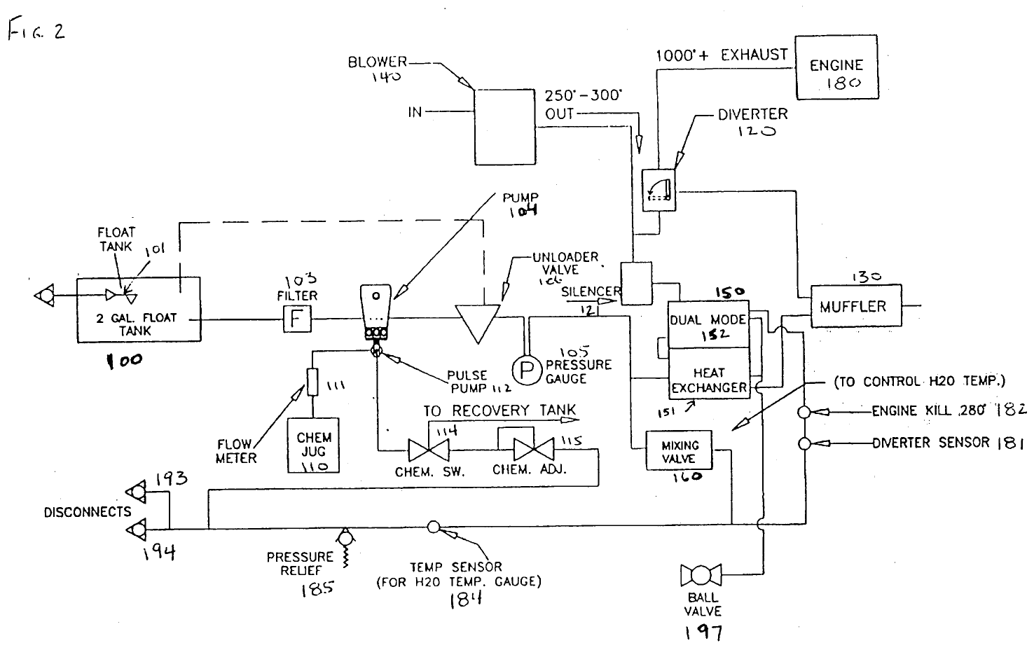

FIG. 2 shows a flow diagram of a carpet cleaning system according to the present invention. A small amount of fresh water (or other suitable fluid) is preferably stored in float tank 100. Because this invention does not require a return path for heated water, the float tank can be much smaller than in traditional systems, and is preferably about 2 gallons. The float tank 100 is preferably in fluid communication with a water source, which can be a large water tank previously used in the conventional bypass system, or another source, such as a garden hose. A float valve 101, or other suitable device known to the skilled artisan, is used to allow the flow of additional water from the water source into the float tank as water is used by the system. The fresh water is then preferably drawn through a filter 103 to remove particles, although the use of a filter is not critical to the operation of the invention. The hydraulic or pressure pump 104 continuously draws water, even during times where the system is not using the water to clean carpets. Alternatively, a clutch can be used with the pump to turn the pump off and not draw water. The water pressure created by the pump 104 can be made viewable, if desired, using pressure gauge 105. This gauge is preferably mounted in a location where it is visible to the operator. Unloader valve 106 is used to insure that the pressure remains in the safe region. In the event of a pressure build-up, the unloader valve is actuated and excess water is removed and preferably returned to the water tank 100.,

The water from pump 104 enters the dual mode heat exchanger 150. In the preferred embodiment, the heat exchanger 150 comprises two heat exchanger stages connected in series. However, it is within the scope of the present invention to design the heat exchanger as a single unit, or in a different configuration. The specific design and implementation of a suitable heat exchanger is well known to those skilled in the art.

In accordance with the present invention, the heat source for the heat exchanger 150 is a mixture comprising the exhaust from several different sources, where the temperature of one exhaust is preferably significantly higher than the other(s). In the preferred embodiment, the exhaust from the blower 140, which is typically in the 250°-300° F. range, is mixed with the exhaust from the system engine 180, which is at a much higher temperature, typically 1000°+ F. Other exhaust combinations are possible, such as using the exhaust from the vehicle's engine in place of a dedicated system engine, or using a combination of the system engine exhaust and vehicle engine exhaust; the invention should not be limited to any particular combination. By mixing varying amounts of exhausts of different temperatures, the system is able to regulate the amount of heat that is used for heat exchange. The location of the merger of these exhausts is not particularly limited; the merger can be accomplished in the ducting, in a suitable mixing chamber or in the heat exchanger itself, for example. These merged exhausts are preferably passed through a silencer 121 to reduce the audible noise. The exhaust is then passed through the heat exchanger 150 and then onto an optional suitable silencing element, such as muffler 130, where it is dispersed into the air.

The flow of the water or other operable fluid in the system, in the preferred embodiment, is as follows. The water enters the first heat exchanger stage 151, where it is heated by the exhaust mixture. The water then continues into the second heat exchanger stage 152, where it continues to be heated. In the preferred embodiment, the partially heated water that exits the first stage of the heat exchanger 151 is also made available for use through ball valIve 197, preferably at the front panel of the unit, by the operator for mixing or diluting chemicals, or for other purposes. The fully heated water then continues to disconnects 193 and 194, where it is available for use. In this embodiment, these disconnects are located on the front panel of the cleaning system and the cleaning hoses are attached to them. Other implementations can be used to connect the heated water from the heat exchanger to the cleaning hoses. These methods are well understood by those skilled in the art.

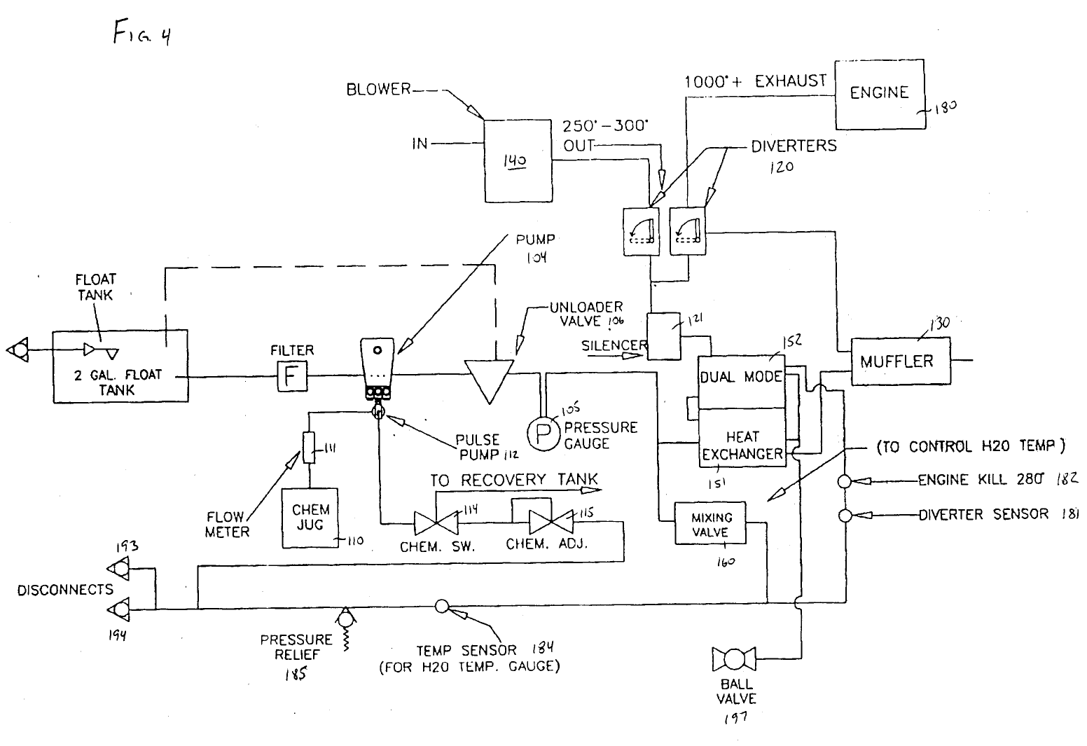

In an alternative embodiment as illustrated in FIG. 4, a diverter 220 can be used to divert the flow from a second or cooler heat source, such as the blower exhaust. This second diverter can be used alone, or in combination with the diverter 120, to further regulate temperature. The diverter 220 thus can redirect the flow of exhaust away from the heat exchanger in response to a predetermined temperature.

Carpet cleaning chemicals can also be mixed with the heated water. In the preferred embodiment, chemical jug 110 contains the required chemicals. A pump draws the chemical from the jug. In this embodiment, this pump is a pulse pump 112, which operates in conjunction with pump 104. Other suitable pumps are possible and are within the skill in the art. The flow rate of the chemical can be monitored by a suitable device, preferably a flow meter 111 directly in the fluid path of the chemical. The flow meter is preferably mounted on the front panel of the system, where it is visible to the operator. The chemical flows to a chemical switch or valve 114. This switch regulates the flow of the chemical and preferably has three positions; off, where no fluid is passed; on, where fluid is passed through the switch; and priming, where fluid is allowed to flow, however it flows along a different path, preferably into the recovery tank. This allows the flow of the chemical to begin without adding it into the heated water. If chemical switch or valve 114 is in the on position, the chemical flows through a suitable adjustable device, such as chemical adjust 115. This device regulates the flow rate of the chemical into the system, which can preferably be monitored by the flow meter 111. The chemical then merges with the heated water before the disconnects 193 and 194.

Several safeguards are used to ensure that the water temperature is within a safe range. A suitable sensor, mounted preferably in or at the output of the heat exchanger 150, is used to detect when the heated water exceeds a predetermined temperature. In the preferred embodiment, the predetermined temperature is adjustable via controls on the front panel, and is preferably in the range from 160°-275° F. The desired temperature is a function of the type of material to be cleaned. In this embodiment, when the temperature reaches the predetermined maximum temperature, this diverter sensor 181 causes diverter 120 to direct the high temperature exhaust away from the dual mode heat exchanger 150 and into the muffler 130, which also serves to muffle the exhaust coming from the heat exchanger 150. This diversion of the engine exhaust reduces the incoming temperature of the exhaust mixture, which will become roughly equal to the temperature of the exhaust of the blower 120. When the water temperature cools sufficiently, preferably about 20° F., the diverter switches positions, allowing the hotter exhaust from the system engine 180 to reenter the heat exchanger. Although in the preferred embodiment all of the high temperature exhaust is diverted upon actuation of the diverter 120, it is within the scope of the present invention to modulate the flow of high temperature exhaust and divert only a portion of the high temperature exhaust to regulate temperature accordingly.

In the preferred embodiment, a second safeguard is used to insure that the heated water never exceeds a second (typically higher) predetermined temperature, preferably about 280° F. Switch 182, mounted preferably in at or the output of the heat exchanger 150, is used to stop the system engine 180 in the event that the heated water exceeds that predetermined temperature. Optionally, a third safeguard can be used to insure that the water within the heat exchanger 150 never overheats. In this embodiment, switch 183, mounted preferably between the first and second stages of the heat exchange, monitors the temperature of water within the heat exchanger. If this temperature exceeds a predetermined value, such as 250° F., the system engine 180 is turned off. Optionally, a mixing valve 160 can be used to mix together the fresh water, before it enters the heat exchanger 150, with heated water, that has exited the heat exchanger 150. By mixing in fresh water, the operator can adjust the temperature of the heated water to a lower temperature than would be possible without the mixing valve. This is important when cleaning materials that require cool water, such as Haitian cotton and fifth generation carpets. In the preferred embodiment, the final temperature of the heated water is monitored by temperature sensor 184 and displayed in a suitable location, preferably on the front panel. Pressure relief 185 is used to relieve any excessive pressure in the system.

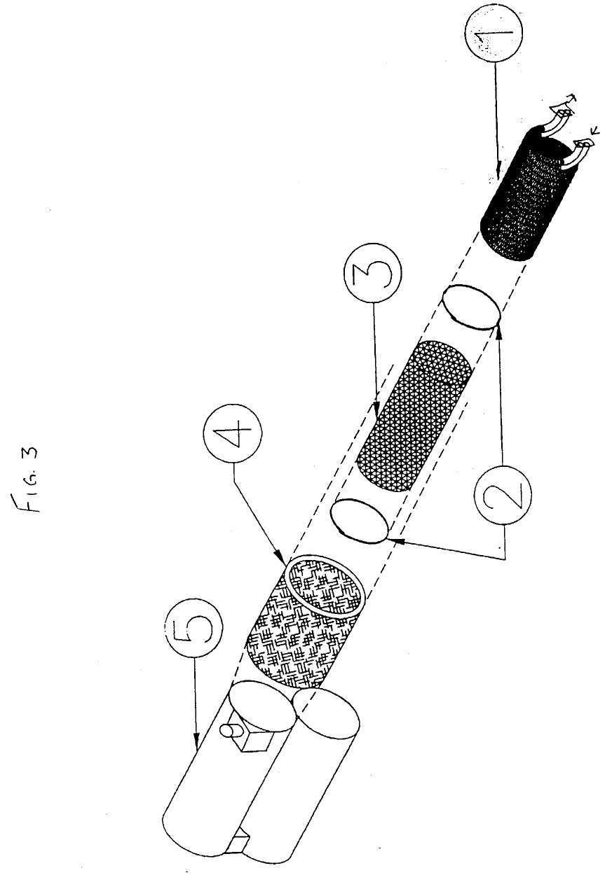

The heat exchanger used in the preferred embodiment also possesses silencing characteristics, which help create a quieter machine. Referring to FIG. 3, a cross section of the at exchanger is shown. The outside of the heat exchanger forms a case around the unit, and is preferably made of sheet metal 5. Inside the sheet metal 5 is a suitable silencing material, preferably fiberglass mat insulation 4. A wire mesh 3 is then placed inside the insulation, and is held in place by suitable means, preferably by retaining straps 2. The water passes through finned copper tubing 1. The fins allow the transfer of heat from the exhaust to the water in the copper tubing. The exhaust flows between the wire mesh 3 and the copper tubing 1. The surface area created by the fins on the copper tubing allows maximum heat transfer.

What is claimed is:

1. A system for heating a fluid to an elevated temperature, comprising a heat exchanger assembly, wherein said fluid flows in close proximity to a higher temperature medium; said higher temperature medium comprising a mixture of a first heat source having a first temperature and a second heat source having a second temperature different from said first temperature.

2. The system of claim 1, wherein said first and second heat sources are the exhaust streams from first and second engines.

3. The system of claim 2, further comprising a diverter, wherein said diverter redirects at least a portion of said exhaust stream from said first heat source away from said heat exchanger assembly when said fluid reaches a predetermined temperature.

4. The system of claim 3, further comprising a second diverter, wherein said second diverter redirects at least a portion of said exhaust stream from said second heat source away from said heat exchanger assembly when said fluid reaches a predetermined temperature.

5. The system of claim 3, wherein said diverter directs said exhaust stream from said first heat source back toward said heat exchanger assembly when the temperature of said fluid has decreased a predetermined amount.

6. A method of heating a fluid to an elevated temperature, using a heat exchanger assembly and a first and a second heat source, comprising merging the outputs of said first and second heat sources, whereby said merged output is used as a heating medium in said heat exchanger assembly, and passing said fluid through said heat exchanger assembly in close proximity to said heating medium to heat said fluid.

7. A method of heating a fluid and maintaining said fluid within a predetermined temperature range, using a heat exchanger assembly, and two heat sources, wherein the first said source is higher in temperature than the second said source, comprising:
merging the outputs of said first and second heat source entering said heat exchanger assembly;
monitoring the temperature of said fluid; and
diverting at least a portion of the output from said first heat source away from said heat exchanger assembly when said fluid temperature reaches the upper limit of said temperature range.

8. The method of claim 7, further comprising diverting at least a portion of the output from said second heat source away from said heat exchanger assembly when said fluid temperature reaches a predetermined value.

9. The method of claim 7, further comprising directing the output from said first heat source toward said heat exchanger assembly when said fluid temperature reaches the lower limit of said temperature range.

10. The method of claim 7, wherein said heat sources are the exhaust streams from respective engines.

11. The method of claim 7, wherein said temperature range is about 20° F.

12. Control system for regulating the temperature of fluid heated in a heat exchanger, comprising:
a heat exchanger;
a first heat exchanger fluid in fluid communication with said heat exchanger and having a first temperature;
a second heat exchanger fluid in fluid communication with said heat exchanger and having a second temperature different from said first temperature;
a temperature sensor for sensing the temperature of said fluid heated by said heat exchanger;
a valve responsive to said temperature sensor for diverting at least a portion of the flow of said first heat exchanger fluid away from said heat exchanger.

13. The control system of claim 12, wherein said valve diverts at least a portion of the flow of said first heat exchanger fluid when said temperature sensor senses a temperature that exceeds a predetermined limit.

14. The control system of claim 12, wherein said valve redirects the flow of said first heat exchange fluid back to said heat exchanger when said temperature sensed by said temperature sensor falls below said predetermined limit.

15. The control system of claim 12, further comprising a second valve responsive to said temperature sensor for diverting at least a portion of the flow of said second heat exchanger fluid away from said heat exchanger.

16. A carpet cleaning system, comprising:
a source of carpet cleaning fluid;
a heat exchanger for heating said carpet cleaning fluid;
a first heat exchanger fluid in fluid communication with said heat exchanger and having a first temperature;
a second heat exchanger fluid in fluid communication with said heat exchanger and having a second temperature different from said first temperature;
a temperature sensor for sensing the temperature of said carpet cleaning fluid heated by said heat exchanger;
a valve responsive to said temperature sensor for diverting at least a portion of the flow of said first heat exchanger fluid away from said heat exchanger; and
a hose in fluid communication with said heated carpet cleaning fluid for applying said heated carpet cleaning fluid to a carpet.

17. The carpet cleaning system of claim 16, wherein said heat exchanger has an output, and wherein all of said heated carpet cleaning fluid flows from said output to said hose.
